(19) United States
(12) Patent Application Publication
(10) Pub. No.: US 2005/0000129 A1
(43) Pub. Date: Jan. 6, 2005

(54) Notice sign for a mailbox

(76) Inventor: Maurice J. Douziech, Edmonton (CA)

Correspondence Address: JEAN M. MACHELEDT, 501 SKYSAIL LANE, SUITE B100, FORT COLLINS, CO, 80525-3133, US

(21) Appl. No.: 10/871,225

(22) Filed: Jun. 18, 2004

Related U.S. Application Data
(63) Continuation-in-part of application No. 29/189,947, filed on Sep. 12, 2003, now Pat. No. D494631.

(30) Foreign Application Priority Data
Jul. 2, 2003 (CA) 103569

(51) Int. Cl. G09F 7/12

(52) U.S. Cl. 40/594

(57) ABSTRACT

The present invention is a notice sign for mounting on a standard mailbox having a convex upper or top surface. The notice sign has a vertical planar member that has a flat surface suitable for bearing a printed message. The vertical planar member has a lower mounting surface for attaching to the sidewall of the mailbox. The notice sign also comprises an upper support member extending from the upper edge of the planar member that further comprises an upper mounting surface for attaching to the convex top surface of the mailbox. The notice sign is preferably attached to the mailbox using strips of double-sided tape although it may also be attached using threaded fasteners passing through the planar member into the sidewall of the mailbox.

### FIELD OF THE INVENTION

The present invention relates to a message or notice sign for mounting on standard mailboxes having a convex upper or top surface.

### BACKGROUND OF THE INVENTION

Along with receiving regularly delivered mail, people often receive numerous pieces of unwanted junk mail or flyers. In addition, people may have uninvited persons, such as door-to-door salesmen or solicitors, coming to their door. In either of these cases, people often put up hand-drawn signs or make their own signs with messages such as “No Flyers or Unaddressed Mail” or “No Solicitors” and mount them on their door or wall-mounted mailboxes.

With standard, post-mounted mailboxes having convex-shaped tops, however, it is not easy to mount such signs due to the curvature of the top. It is, therefore, desirable to have a notice sign that easily and effectively mounts on such standard, convex-top mailboxes.

### SUMMARY OF THE INVENTION

The present invention is a notice sign suitable for mounting on the sidewall of a standard mailbox having a convex upper or top surface. The notice sign comprise a vertical planar member with a flat surface that is suitable for bearing a printed message. The message may be a notice to the postman not to deliver unaddressed mail, a notice not to place flyers in the mailbox, or a notice that solicitors are not welcome. The lower edge of the planar member attaches to a sidewall of the mailbox along a lower line of contact.

Attached to the planar member along its top edge is an upper support member that extends outwardly away from the front surface of the planar member. The upper support member bends or curls downwardly, back towards the planar member and provides an upper line of contact with the convex top of the mailbox thereby providing the notice sign an upper line of contact. The upper support member is sized and configured to keep the flat surface of the planar member vertical when the notice sign is attached to the the mailbox.

The upper support member may have a curved surface that is approximately circular in cross section. The curved surface may be convex to form a thin line of contact with the top of the mailbox. Alternatively, the curved surface may be concave to match the curvature of the mailbox top to form a thick line of contact.

Another embodiment of the upper support member comprising a planar contact surface that forms the line of contact with the mailbox top. The planar contact surface may also extend towards and intersect with the vertical planar member to provide additional rigidity to the notice sign.

To mount the notice sign to the mailbox, it is preferred to use strips of double-sided tape in between the sign and the mailbox along the upper and lower lines of contact. Alternatively, it is possible to mount the notice sign to the mailbox by simply passing a threaded fastener through the planar member into the sidewall of the mailbox along the lower edge of the notice sign.

In the preferred embodiment of the present invention, the vertical planar member and the upper support member are formed from a single piece of planar material such as plexiglas or plastic although other suitable materials as known to those skilled in the art, such as wood or metal, may be used.

Broadly stated, the present invention is a notice sign for a mailbox having a convex upper surface, comprising: a vertical planar member having exterior and interior surfaces and upper and lower edges, the exterior surface suitable for bearing a printed message, the interior surface defining a lower line of contact for a sidewall of said mailbox, said lower line of contact located near the lower edge of said vertical planar member; an upper support member operatively attached to the upper edge of said vertical planar member, the upper support member extending outwardly from the interior surface of said vertical planar member, the upper support member adapted to support said notice sign on the convex upper surface of said mailbox by defining an upper line of contact for said convex upper surface; and means for attaching said notice sign to said mailbox.

### DESCRIPTION OF THE DRAWINGS

FIG. 1 is a perspective view showing one embodiment of the notice sign of the present invention.

FIG. 2 is a perspective view of one embodiment of the present invention as mounted on a mailbox.

FIG. 3 is a perspective view of an alternate embodiment of the present invention.

FIG. 4 is an end view of a second alternate embodiment of the present invention as mounted on a mailbox.

FIG. 5 is an end view of a third alternate embodiment of the present invention as mounted on a mailbox.

### DESCRIPTION OF THE PREFERRED EMBODIMENT

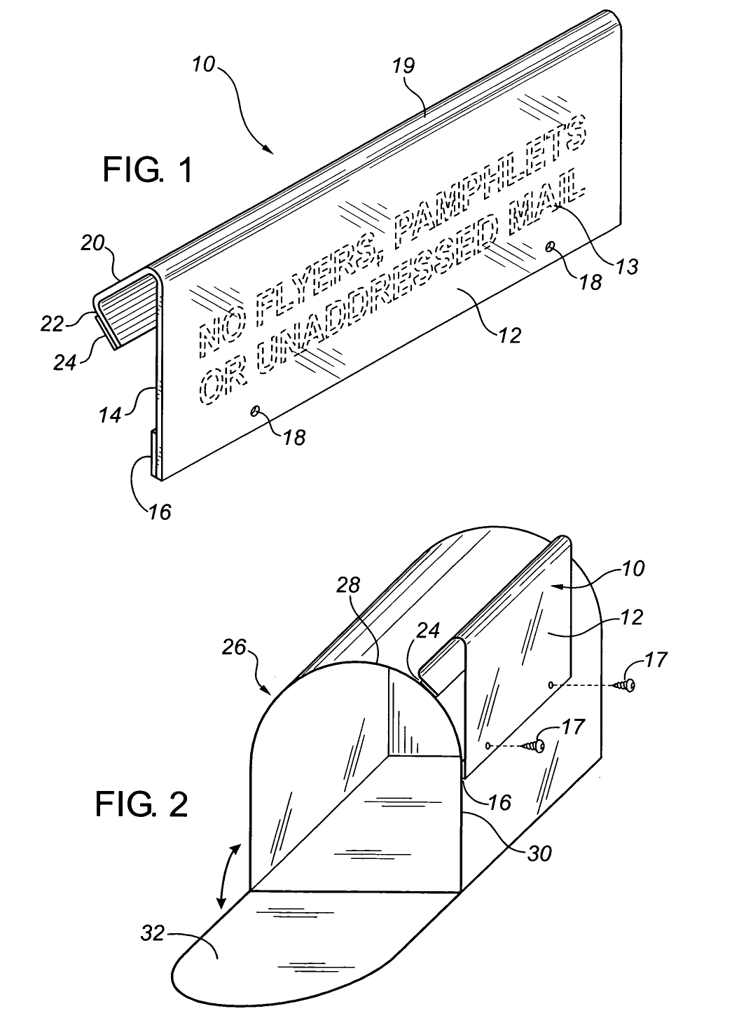

Referring to FIG. 1, notice sign 10 comprises vertical planar member 12, which provides a flat surface for bearing printed message 13, and is preferably rectangular. Attached to planar member 12 along upper edge 19 is upper support member 20. Planar member 12 comprises lower mounting surface 14 and upper support member 20 further comprising upper mounting surface 22.

Referring to FIG. 2, notice sign 10 is shown mounted on mailbox 26. Mailbox 26 comprises upper or top convex surface 28 and sidewall 30. Notice sign 10 is, preferably, attached to mailbox 26 using double-sided tape 24 between upper mounting surface 22 and convex surface 28 and double-sided tape 16 between lower mounting surface 14 and sidewall 30. Alternatively, threaded fastener 17 can be used to attach notice sign 10 to mailbox 26 by passing through hole 18 into sidewall 30.

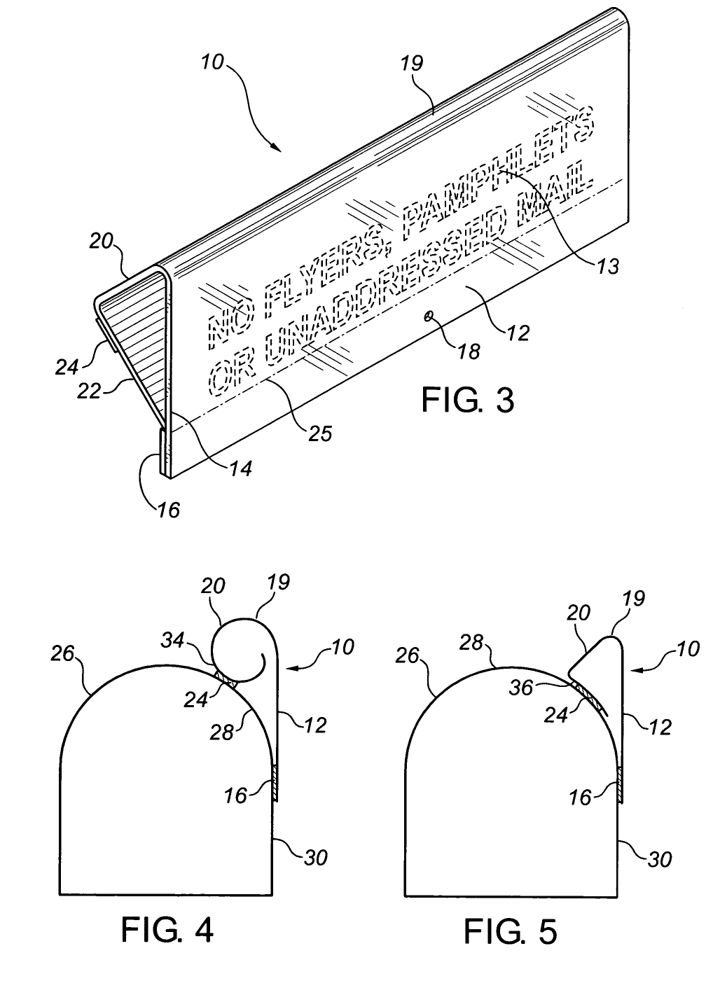

Referring to FIG. 3, an alternate embodiment of notice sign 10 is shown wherein upper mounting surface 22 extends towards lower mounting surface 14 and adjoins planar member 12 along intersection line 25. In this and the preceding embodiment, upper mounting surface 22 is planar.

Referring to FIG. 4, a second alternate embodiment of the present invention is shown mounted on mailbox 26. In this embodiment, upper support member 20 has a curved upper mounting surface 34 that is convex. This embodiment provides for a thin line of contact with convex surface 28 through upper mounting strip 24.

Referring to FIG. 5, a third alternate embodiment of the present invention is shown mounted on mailbox 26. In this embodiment, upper support member 20 has a curved upper mounting surface 36 that is concave. This embodiment provides for a thick line of contact with convex surface 28 through upper mounting strip 24.

It is envisioned that a number of variants in the cross-sectional shape of upper support member 20 may be employed while still providing the functional features described herein. Any such changes in the cross-sectional shape of upper support member 20 would be purely ornamental.

While the preferred embodiment of the present invention is made from a single piece of plastic or plexiglas, it should be obvious to those skilled in the art that the present invention may be assembled from a number of pieces of material and may be made from other materials with similar structural properties such as, but not limited to, wood or metal.

Although a few preferred embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized at the scope of the invention as defined and limited only by the claims that follow.

1. A notice sign for a mailbox having a convex upper surface, comprising:
a) a vertical planar member having exterior and interior surfaces and upper and lower edges, the exterior surface suitable for bearing a printed message, the interior surface defining a lower line of contact for a sidewall of said mailbox, said lower line of contact located near the lower edge of said vertical planar member;
b) an upper support member operatively attached to the upper edge of said vertical planar member, the upper support member extending outwardly from the interior surface of said vertical planar member, the upper support member adapted to support said notice sign on the convex upper surface of said mailbox by defining an upper line of contact for said convex upper surface; and
c) means for attaching said notice sign to said mailbox.

2. The notice sign as set forth in claim 1 wherein the planar member is rectangular.

3. The notice sign as set forth in claim 1 wherein said attachment means comprise double-sided tape for operatively attaching said notice sign to said mailbox along said upper and lower lines of contact.

4. The notice sign as set forth in claim 1 wherein said attachment means comprise said vertical planar forming a hole near the lower edge through which a threaded fastener may be threaded into the sidewall of said mailbox thereby securing said notice sign to said mailbox.

5. The notice sign as set forth in claim 1 wherein the upper line of contact is defined on a curved support surface of said upper support member.

6. The notice sign as set forth in claim 5 wherein at least a portion of said upper support member is circular in cross section.

7. The notice sign as set forth in claim 1 wherein the upper line of contact is defined on a planar support surface of said upper support member.

8. The notice sign as set forth in claim 7 wherein said upper support member comprises at least two planar surfaces.

9. The notice sign as set forth in claim 7 wherein said planar support surface intersects with the interior surface of said vertical planar member.

10. The notice sign as set forth in claim 1 wherein the planar member is selected from the group consisting of plexiglas, plastic, wood and metal.

11. The notice sign as set forth in claim 10 wherein the vertical planar member and the upper support member are formed from a single piece of planar material.
